(19) United States
(12) Patent Application Publication
(10) Pub. No.: US 2026/0022067 A1
(43) Pub. Date: Jan. 22, 2026

(54) SUPPLEMENTARY CEMENTITIOUS MATERIAL

(71) Applicant: CRH Group Services Limited, Dublin 2 (IE)

(72) Inventor: Pedro Silva HUMBERT, Amsterdam (NL)

(73) Assignee: CRH Group Services Limited, Dublin 2 (IE)

(21) Appl. No.: 19/141,760

(22) PCT Filed: Dec. 20, 2023
(86) PCT No.: PCT/EP2023/086940

§ 371 Date: Jun. 20, 2025

(30) Foreign Application Priority Data
Dec. 22, 2022 (EP) 22216257.0
May 31, 2023 (EP) 23176397.0

(51) Int. Cl. C04B 20/02; C04B 14/06; C04B 14/30; C04B 20/04

(52) U.S. Cl. CPC C04B 20/0232; C04B 14/06; C04B 14/305; C04B 20/04

(57) ABSTRACT

The invention relates to a method of producing a supplementary cementitious material (SCM) comprising:

a) providing a particulate mineral material;

b) mixing the mineral material with water to form a mixture;

c) milling the mixture in the presence of carbon dioxide to form a slurry, wherein the concentration of carbon dioxide is greater than about 8 vol %; and;

d) drying the slurry to form the SCM.

The present invention relates to a method of making a supplementary cementitious material (SCM), a use of a SCM, a method of producing concrete, a method of producing mortar and a method producing cement.

### BACKGROUND TO THE INVENTION

Increasing levels of atmospheric carbon dioxide are known to have a range of negative effects on the environment. Carbon dioxide is the primary greenhouse gas contributing to climate change and plays a significant role in ocean acidification.

Industrial activity is a major contributor to the increasing concentration of carbon dioxide in the atmosphere. The burning of fossil fuels for energy and the manufacture of construction materials, such as steel, cement and lime, result in the generation of large amounts of carbon dioxide, predominantly through the emission of flue gases from industrial plants. Growing pressure on governments to act on climate change has led to increased legislation limiting carbon emissions from industry.

SCMs are materials that are used in methods of making concrete and mortar, often to replace or reduce the amount of Portland cement used.

There is a need for more sustainable industrial processes with reduced carbon emissions. Further, there is a need for processes that capture carbon dioxide during the manufacture of construction materials. Further, there is a need for processes with improved carbon dioxide capture efficiency. Further, there is a need to enhance the cement hydration reaction in concrete, mortar or cement. Further, there is a need to improve the compressive strength development of the concrete, mortar or cement. Further, there is a need to reduce the amount of clinker, such as cement clinker and Portland clinker, used in concrete, mortar and cement. Further, there is a need for processes that make use of waste flue gas from other industrial activities. Further, there is a need to reduce the time required for concrete or mortar to set and increase the number of product cycles possible per day.

It is, therefore, an object of the present invention to seek to alleviate the above identified problems.

### SUMMARY OF THE INVENTION

In the first aspect of the present invention, there is provided a method of producing a supplementary cementitious material (SCM) comprising:
a) providing a particulate mineral material;
b) mixing the mineral material with water to form a mixture;
c) milling the mixture in the presence of carbon dioxide to form a slurry, wherein the concentration of carbon dioxide is greater than about 8 vol %; and;
d) drying the slurry to form the SCM.

In a second aspect of the present invention, there is provided an SCM produced by the method to the first aspect of the invention.

In a third aspect of the present invention, there is provided use of an SCM produced by the method according to the first aspect of the invention, or an SCM according to the second aspect of the invention, as a construction material.

In a fourth aspect of the invention, there is provided a method of producing concrete comprising:
i. providing a SCM produced according to the first aspect of the invention or an SCM according to the second aspect of the invention;
ii. providing sand and an aggregate;
iii. mixing the SCM, the sand, and the aggregate with water to form a mixture; and
iv. curing the mixture to form concrete.

In a fifth aspect of the invention, there is provided a method of producing mortar comprising:
A. providing a SCM produced according to the first aspect of the invention or an SCM according to the second aspect of the invention;
B. providing sand;
C. providing water; and
D. mixing the SCM, the sand, and the water to form mortar.

In a sixth aspect of the invention, there is provided a method of producing cement comprising:
I. providing a SCM produced according to the first aspect of the invention or an SCM according to the second aspect of the invention;
II. providing a clinker; and
III. mixing the SCM and clinker to form cement.

### DETAILED DESCRIPTION

The present invention relates to a method of producing a supplementary cementitious material (SCM) comprising:
a) providing a particulate mineral material;
b) mixing the mineral material with water to form a mixture;
c) milling the mixture in the presence of carbon dioxide to form a slurry, wherein the concentration of carbon dioxide is greater than about 8 vol %; and;
d) drying the slurry to form the SCM.

It is an advantage of the present invention that carbon dioxide is captured, which reduces carbon emissions to the atmosphere. In particular, the present invention can reduce industrial carbon emissions by capturing and storing carbon dioxide in the SCM of the invention, preventing its release to the atmosphere. It is a further advantage that the process of the invention can be carbon neutral or carbon negative. As shown in the examples, the method of the invention allows more carbon dioxide to be captured by carrying out step c, milling in the presence of carbon dioxide, rather than milling and then treating the material with carbon dioxide or treating the material with carbon dioxide and then milling it. This leads to a more efficient process as surprisingly, the method of the present invention is quicker and captures more carbon dioxide.

It is a further advantage that the cement hydration reaction can be enhanced by using the SCM of the present invention in concrete, mortar or cement. It is a further advantage that compressive strength development of the concrete, mortar or cement can be enhanced by the present invention. It is a further advantage that use of the SCM can reduce the need for clinker, such as cement clinker and Portland clinker, in concrete, mortar and cement.

It is a further advantage that milling the mixture in the presence of carbon dioxide can provide additional carbonation of the mixture, increasing carbon dioxide uptake compared to similar processes without this step.

It is a further advantage that milling the mixture in the presence of carbon dioxide can reduce the time required for the mixture to set, reducing the setting time compared to similar processes without this step. This leads to a more efficient process, as the method of the present invention is quicker and increases the number of product cycles possible per day.

Preferably milling means reducing the size of particles of particulate material. Preferably, the milling step comprises using a ball mill. Preferably, milling comprises grinding.

Preferably, the method further comprises
e) deagglomerating the SCM.

The drying step may cause the SCM to agglomerate into agglomerates of SCM particles. The deagglomerating step increases the surface area of the SCM and allows the SCM to be further mixed with other components, such as in the production of concrete or mortar. Preferably, deagglomerating means separating the SCM into particulate form. This differs from milling as the aim is to separate the SCM into particulate form, rather than reducing the size of particles of the SCM.

Preferably, step (e) comprises deagglomerating and milling the SCM.

An advantage of a further milling step after drying is that it breaks down the carbonated shell of the SCM, exposing additional unreacted area for carbonation. This means that further carbon dioxide may react with the SCM, such as in the production of concrete or mortar. This has the dual advantage of capturing more carbon dioxide and increasing the reactivity of the SCM. This leads to concrete, mortar or cement with a higher compressive strength.

Preferably, the mineral material comprises a calcium oxide, a magnesium oxide, a calcium silicate, a magnesium silicate, an iron oxide or a combination of two or more thereof, preferably a calcium oxide, a magnesium oxide or a combination of the two.

An advantage of the method is that carbon dioxide emissions are reduced by capturing carbon dioxide in the SCM. The following reaction schemes show the capture of carbon dioxide.

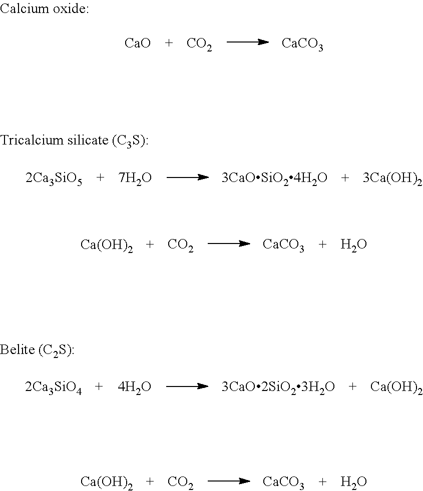

Preferably, the particulate mineral material comprises blast furnace slag, meta kaolin, calcinated clay, serpentine, Portland cement, cement by-pass dust, lime kiln dust, cement kiln dust, air pollution control residue, Portland clinker, cement, limestone powder, quicklime, rock fines, concrete fines, mine tailings, fly ash, bottom ash, biomass ash, metallurgy slag, red mud, paper ash, dusts, oil shale ash, metal silicate powder, metal hydroxide powder, calcium sulphate, pozzolanic material or bleaching earth material, or any combination of two or more thereof, preferably, the particulate mineral material comprises blast furnace slag, metallurgy slag, Portland cement, Portland clinker, cement, air pollution control residue or any combination of two or more thereof, preferably, the particulate mineral material comprises steel slag, stainless steel slag, copper slag, lead slag, Portland cement, Portland clinker, cement, cement by-pass dust, lime kiln dust, cement kiln dust, fly ash or bottom ash or any combination of two or more thereof, preferably the particulate mineral material comprises blast furnace slag or metallurgy slag, preferably steel slag or stainless steel slag.

Preferably, the particulate mineral material comprises blast furnace slag, cement by-pass dust, lime kiln dust, cement kiln dust, concrete fines, mine tailings, fly ash, bottom ash, metallurgy slag, red mud, metal silicate powder, metal hydroxide powder, or any combination of two or more thereof, preferably wherein the particulate mineral material comprises blast furnace slag, cement by-pass dust, lime kiln dust, cement kiln dust, concrete fines, mine tailings, fly ash, bottom ash, metallurgy slag, red mud, or any combination of two or more thereof.

Preferably, the particulate mineral material comprises metallurgy slag, preferably steel slag or stainless steel slag, and the method further comprises:
e) deagglomerating the SCM, preferably deagglomerating and milling the SCM. An advantage of combining the particulate mineral material comprising metallurgy slag, which is particularly prone to agglomeration, with a further deagglomeration step is that it further increases the surface area of the SCM and allows the SCM to be further mixed with other components, such as in the production of concrete or mortar.

Preferably, the particulate material does not comprise cement clinker or Portland clinker. Preferably, the liquid to solid ratio in step (b) is in the range of about 5 to about 1 to about 1 to about 1, preferably wherein the liquid to solid ratio is about 5 to about 1, most preferably wherein the liquid to solid ratio is about 2 to about 1. It is an advantage of these proportions that they optimise the volume of water in the system for milling. Preferably, the liquid to solid ratio is a weight ratio.

Preferably, the water comprises ground water, tap water, seawater or a combination of two or more thereof. It is an advantage of the invention that different sources of seawater can be used.

Preferably, the water comprises seawater. An advantage of using seawater is that it is an abundant resource and can be recycled and returned to the mill, lessening the environmental impact of the process.

Preferably the mixture in step (b) further comprises from about 0.1 wt % to about 5 wt % sodium hydroxide, preferably from about 0.5 wt % to about 3 wt % sodium hydroxide, preferably from about 1 wt % to about 2 wt % sodium hydroxide.

An advantage of adding sodium hydroxide to the mixture is that it increases the rate of carbonation. This increases the efficiency of the process by reducing time and energy costs.

Preferably, the mixture in step (b) further comprises from about 0.1 wt % to 5 wt % of titanium dioxide, preferably from about 0.5 wt % to about 3 wt % titanium dioxide, preferably about 1 wt % titanium dioxide.

Preferably, the concentration of carbon dioxide in step (b) is greater than about 8 vol %, preferably in the range of about 8 vol % to about 100 vol %, preferably in the range of about 10 vol % to about 50 vol %, preferably in the range of about 13 vol % to about 20 vol %. These amounts allow a sufficient rate of reaction.

Preferably, the carbon dioxide in step (b) comprises flue gas. It is an advantage of the process of the present invention that the gas comprising carbon dioxide can be the waste flue gas produced from other industrial activities. Trapping and storing carbon dioxide that would otherwise have been released into the atmosphere reduces the environmental impact of such processes.

Preferably, carbon dioxide gas is introduced directly into the mixture in step (b) and/or step (c). This allows the carbon dioxide to react efficiently with the mineral material.

Preferably, carbon dioxide is added as step c is carried out, preferably there is a continuous supply of carbon dioxide in step c. This allows the concentration of the carbon dioxide to be kept at the desired level as the carbon dioxide is captured in the slurry.

An advantage of adding titanium dioxide to the mixture is that it acts as a photocatalyst in the photocatalytic abatement of nitrogen and sulphur oxide. Removal of nitrogen and sulphur oxide pollutants prevents their release into the atmosphere, where they have been known to have harmful ecological effects. This is particularly useful when flue gas is used to provide carbon dioxide. A further advantage of adding titanium dioxide to the mixture is that it is known to improve mechanical properties of the product, such as compressive strength.

Preferably, step (c) is carried out at a temperature of at least about 40° C., preferably in the range of about 40° C. to about 99° C., preferably in the range of about 50° C. to about 70° C. An advantage of this temperature range is that it provides a sufficient rate of reaction, while minimising energy consumption and the associated costs. Such temperatures avoid the formation of steam, enabling carbonation to progress efficiently.

Preferably, the concentration of carbon dioxide in step (c) is in the range of about 8 vol % to about 100 vol %, preferably in the range of about 10 vol % to about 50 vol %, preferably in the range of about 13 vol % to about 20 vol %. These amounts allow a sufficient rate of reaction.

Preferably, the carbon dioxide in step (c) comprises flue gas. It is an advantage of the process of the present invention that the gas comprising carbon dioxide can be the waste flue gas produced from other industrial activities. Trapping and storing carbon dioxide that would otherwise have been released into the atmosphere reduces the environmental impact of such processes.

Preferably, wherein the D90 particle size of the mineral material is less than about 50 mm, preferably from about 100 μm to about 5 mm, preferably from about 200 μm to about 5 mm, preferably from about 300 μm to about 1 mm. An advantage of using particulate material of such sizes is to increase carbonation efficiency. A further advantage the particle size is that they are easily handled using existing apparatus, eliminating the need for significant modifications.

Preferably, the D90 particle size of the SCM is from about 60 μm to about 500 μm, preferably from about 50 μm to about 300 μm, preferably from about 70 μm to about 110 μm, preferably from about 80 μm to about 90 μm. An advantage of such sizes is that the SCM is easily incorporated into the forming mixture during the production of construction materials.

The average particle size may be measured by laser diffraction or sieving, preferably by laser diffraction, preferably using a Mastersizer 3000E instrument with dry powder disperser.

Preferably, step (c) is carried out at a pressure in the range of about 1 bar to about 3 bar, preferably about 1 bar. An advantage of using this range is that it provides a sufficiently high rate of reaction, while minimising energy consumption and associated costs. It is an advantage that the process can be carried out at standard pressure, as this reduces the costs and complexity of the process.

Preferably, the milling time in step (c) is in the range of about 2 hours and about 5 hours, preferably about 3 hours to about 4 hours. An advantage of using this range is that it maximises carbonation of the mineral material, while minimising the time required.

Preferably, the milling step is carried out in a ball mill. This is a suitable apparatus to use.

Preferably, the speed of mixing of the ball mill is about 70% to about 99% of the critical speed of the ball mill. This allows efficient milling. The critical speed of the mill may be calculated as shown below:

$$CS = 1 / 2 π √ ( g / ( R - r )$$

where g is the gravitational constant, R is the inside diameter of the mill and r is the diameter of one piece of media.

FIG. 1 shows that when the mill is static, the particulate material is at the bottom of the mill. When the milling speed is increased to about 50% to about 65% of the critical speed, mixing and milling starts to occur. When the milling speed is increased to about 70% to about 99% of the critical speed, optimal mixing and milling occurs. When the milling speed is 100% of the critical speed, the centrifugal force means that the particulate material is forced to the outside of the mill and thus the mixing and milling is reduced compared to when the mixing speed is about 70% to about 99% of the critical speed.

Preferably, the method is a continuous process. This provides an efficient process.

Preferably, step (d) comprises heating, filtering, centrifuging or a combination of two or more thereof, preferably heating.

Preferably, wherein step (d) is carried out at a temperature from about 40° C. to about 120° C., preferably about 60° C. to about 110° C., preferably about 95° C. to about 105° C. An advantage of using this temperature range is that it provides a sufficiently high rate of drying, while minimising energy consumption and the associated costs. Carrying out step (d) within the range of about 95° C. to about 105° C. encourages the evaporation of water from the slurry while minimising energy usage.

Preferably, the concentration of carbon dioxide in step (d) is greater than about 8 vol %; preferably in the range of about 8 vol % to about 100 vol %, preferably in the range of about 13 vol % to about 20 vol %.

Preferably, the drying time in step (d) is from about 1 hour to about 24 hours, preferably about 1 hour to about 5 hours, preferably about 2 hours to about 4 hours. An advantage of drying for this length of time is that it ensures that the slurry is sufficiently dry for step (e) to be carried out, while minimising the time and energy required.

Preferably, the SCM comprises less than about 5 wt % water, preferably less than about 2 wt % water, preferably less than about 1 wt % water, preferably the SCM is substantially dry.

It will be appreciated that the drying time and temperature can be adjusted to achieve the desired water content of the SCM.

Preferably, the slurry is dried using flue gas, preferably flue gas from a cement plant. It is an advantage of the process of the present invention that the gas comprising carbon dioxide can be the waste flue gas produced from other industrial activities. Trapping and storing carbon dioxide that would otherwise have been released into the atmosphere reduces the environmental impact of such processes.

Preferably, the temperature of the flue gas is from about 120° C. to about 180° C. It is an advantage that waste flue gas produced from other industrial activities can be used for drying and heating, as this reduces energy consumption and the associated costs.

Preferably, flue gas is used to provide the carbon dioxide in step (c) and to dry the slurry in step (d), preferably wherein the flue gas is recycled in steps (c) and (d). Preferably, flue gas is used to provide the carbon dioxide in steps (b) and (c) and to dry the slurry in step (d), preferably wherein the flue gas is recycled in steps (c) and (d). It is an advantage that flue gas can be reused in this way. This allows the thermal energy from the flue gas to be used in the drying step and carbonation to occur in both steps (c) and (d). This is an energy efficient use of waste materials.

Preferably the amount of carbon dioxide capture in Step b in about 0 vol % to about 20 vol % of the carbon dioxide captured in the method of making the SCM. Preferably the amount of carbon dioxide capture in Step c in about 70 vol % to about 90 vol % of the carbon dioxide captured in the method of making the SCM. Preferably the amount of carbon dioxide capture in Step d in about 0 vol % to about 20 vol % of the carbon dioxide captured in the method of making the SCM. It is an advantage that most of the capture of carbon dioxide occurs during milling step c. The milling step increases the surface area of the mineral material which increases the area available to capture carbon dioxide. Some carbon dioxide capture can occur prior to milling, and some can occur after milling.

The present invention relates to a SCM produced by the method of any preceding claim

The present invention relates to the use of an SCM produced by the method as described herein or an SCM as described herein, as a construction material, preferably in a method of producing concrete, mortar or cement.

It is an advantage of the method of the present invention that it can be used to produce a variety of materials, offering a range of potential applications in construction projects.

The present invention relates to a method of producing concrete comprising:
i. providing a SCM produced as described herein or an SCM as described herein;
ii. providing sand and an aggregate;
iii. mixing the supplementary cementitious material, the sand, and the aggregate with water to form a mixture; and
iv. curing the mixture to form concrete.

The present invention relates to a method of producing mortar comprising:
A. providing a SCM produced as described herein or an SCM as described herein;
B. providing sand;
C. providing water; and
D. mixing the SCM, the sand, and the water to form mortar.

The present invention relates to a method of producing cement comprising:
I. providing a supplementary cementitious material produced as described herein or an SCM as described herein;
II. providing a clinker;
III. mixing the SCM and clinker to form cement.

Preferably, step Ill comprises milling the clinker and the SCM. This allows the particle size of both to be controlled and aids the mixing.

Preferably, the SCM of step I is ground prior to mixing step III. This allows the particle size of the SCM to be controlled.

Preferably, the clinker of step Il is ground prior to mixing step III. This allows the particle size of the clinker to be controlled.

Preferably the clinker is cement clinker, preferably Portland clinker. This is commonly used to form cement.

It is an advantage of the invention that the amount of clinker used in cement can be reduced by replacing some of the clinker with the SCM of the invention.

### BRIEF DESCRIPTION OF THE FIGURES

FIG. 1 shows the effect on mixing of the speed of the mill

FIG. 2 shows the particle size distribution of a particulate mineral material

FIG. 3 shows a TG-DTA curve of a particulate mineral material

FIG. 4 shows the particle size distribution of Example A after treatment

FIG. 5 shows the particle size distribution of Example B after treatment

FIG. 6 shows the particle size distribution of Example C after treatment

FIG. 7 shows the carbon dioxide uptake results of Examples A, B and C

FIG. 8 shows the rate of heat evolution for the Reference sample and Samples D, E and F

FIG. 8A shows the rate of heat evolution for the Reference sample

FIG. 8B shows the rate of heat evolution for Sample D

FIG. 8C shows the rate of heat evolution for Sample E

FIG. 8D shows the rate of heat evolution for Sample F

FIG. 9 shows the rate of heat evolution and its derivative for the Reference sample and Samples D, E and F during the acceleratory stage

FIG. 9A shows the rate of heat evolution and its derivative for the Reference sample during the acceleratory stage

FIG. 9B shows the rate of heat evolution and its derivative for Sample D during the acceleratory stage

FIG. 9C shows the rate of heat evolution and its derivative for Sample E during the acceleratory stage

FIG. 9D shows the rate of heat evolution and its derivative for Sample F during the acceleratory stage

FIG. 10 shows the initial and final setting times for the Reference sample and Samples D, E and F

FIG. 11 shows the normalised cumulative heat release during the calorimetry test for the Reference sample and Samples D, E and F

FIG. 11A shows the normalised cumulative heat release during the calorimetry test for the Reference sample

FIG. 11B shows the normalised cumulative heat release during the calorimetry test for Sample D

FIG. 11C shows the normalised cumulative heat release during the calorimetry test for Sample E

FIG. 11D shows the normalised cumulative heat release during the calorimetry test for Sample F

FIG. 12 shows the total normalised cumulative heat release for the Reference sample and Samples D, E and F

FIG. 13 shows the specific heat release for the Reference sample and Samples D, E and F, normalised to the Reference sample

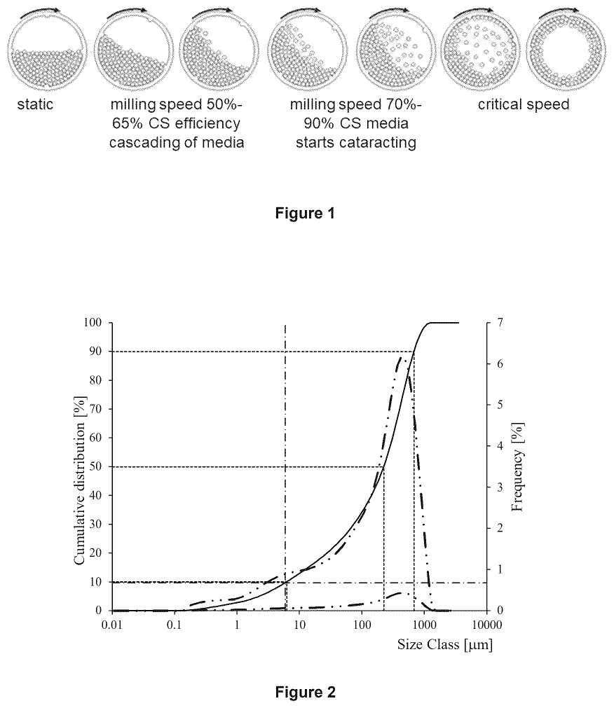

### EXAMPLES

### Example 1

Ground steel converter slag was sieved to have a maximum particle size of 1 mm. The resulting particle size distribution curve of the particulate mineral material, assessed by means of Mastersizer 3000E instrument with dry powder disperser, is shown in FIG. 2 both in terms of cumulative distribution and frequency. Characteristic values of diameter are d10 equal to 6.2 μm, d50 equal to 224 μm and d90 equal to 683 μm

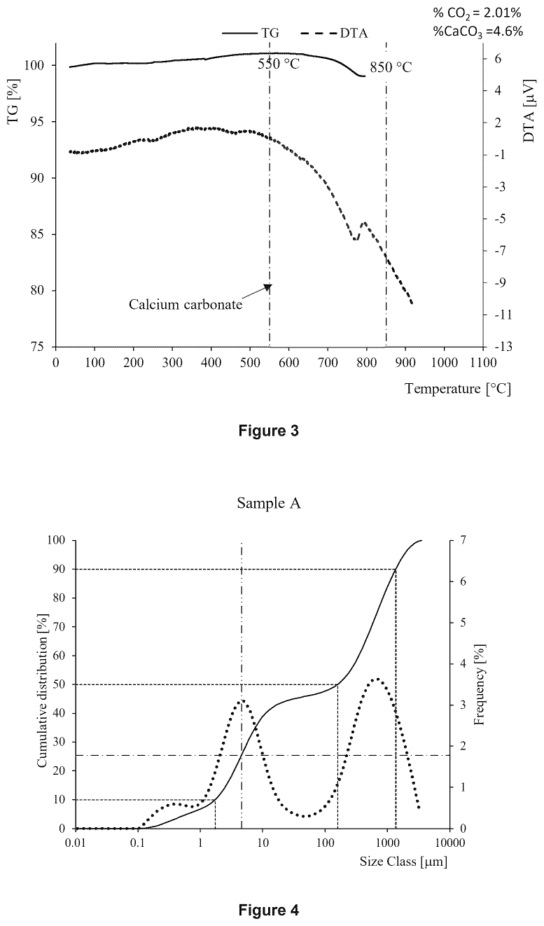

The initial carbon dioxide content of the particulate material is assessed via thermogravimetric and differential thermal analysis. Specifically, from TG-DTA curve shown in FIG. 3, the carbon dioxide content is assessed by the ratio between the loss of mass in the temperature range 550° C.-850° C. and the initial mass of the particulate material. The initial carbon dioxide content is equal to 2.01%.

Table 1 shows the processes applied to three Examples with Example A being in accordance with the invention.

TABLE 1

| Example | First process (2 hours) | Second process (2 hours) |
|---|---|---|
| A | Wet milling and wet carbonation | n/a |
| B | Wet milling | Wet carbonation |
| C | Wet carbonation | Wet milling |

Treatments are carried out in plastic bottles with 6 cm diameter and with a maximum capacity of 250 ml.

The milling process used a ball mill, using 5 mm zirconia balls as grinding media. The liquid-to-solid ratio of the slurry equal to 2 (47.0 g of water, 23.75 g of powdered steel slag).

The carbonation process used a constant injection of pure carbon dioxide gas inserted in the bottle with a flow rate equal to 50 l/h. During carbonation the bottle is not perfectly sealed to achieve ambient pressure conditions.

After the treatment the slurry is separated from the grinding media by means of deionised water, then the water in excess is removed by centrifugation process, and the powder is obtained by drying the resulting cake in the oven at 60° C. for 24 h.

### Example A: Combined Wet Milling-Carbonation According to the Invention

Particle size distribution of the treated powder after combined wet milling-carbonation treatment is shown in FIG. 4. The curve shows a double peak behaviour. On one side, the number of smaller particles increases due to the milling (peak corresponding to diameter d* of 4.58 μm in FIG. 4, with a cumulative value of 25.5%). On the other side, a significant presence of larger particles (also larger than 1 mm) is recorded as well due to an agglomeration of the smaller particles during the drying process. Given the shape of the frequency curve, together with the characteristic diameters, the diameter d*, and the corresponding cumulative value, are considered as well to verify the efficiency of the milling. All in all, the curve shows a significant reduction of the particles size due to the milling process.

### Example B: Wet Milling, Then Wet Carbonation (Comparative Example)

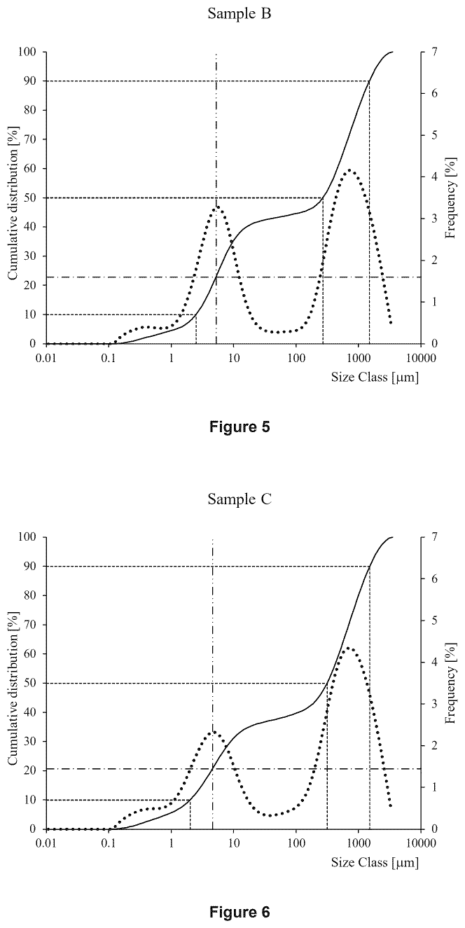

Particle size distribution of the treated powder after wet miling, then wet carbonation (Example B) treatment is shown in FIG. 5. The curve shows the same behaviour showed by Example B as Example A. The diameter d′ is equal to 5.21 μm, with a corresponding cumulative value of 22.9%. All in all, the curve shows a significant reduction of the particles size due to the milling process compared to the raw material. Moreover, comparing the results with Example A, no significant differences can be observed, confirming that milling conditions adopted in Example B reproduce those of Example A.

### Example C: Wet Carbonation, Then Wet Milling (Comparative Example)

Particle size distribution of the treated powder after wet carbonation, then wet milling (Example C) treatment is shown in FIG. 6. The curve shows the same behaviour showed by Example C as Example A. The diameter d′ is equal to 4.58 μm, with a corresponding cumulative value of 20.7%. All in all, the curve shows a significant reduction of the particles size due to the milling process compared to the raw material. Moreover, comparing the results with Example A, no significant differences can be observed, confirming that milling conditions adopted in Example C reproduce those of Example A.

It will be appreciated that a further step of deagglomeration of Samples A, B and C could be used.

Three samples were extracted from treated powder of each Example and subjected to thermal decomposition in muffle furnace for the carbon dioxide uptake assessment. Results, including average, standard deviation and coefficient of variation are reported in Table 2.

TABLE 2
carbon dioxide uptake results of Examples A, B and C

| | Batch 1 | Batch 2 | Batch 3 | | | |
|---|---|---|---|---|---|---|
| | % CO₂ | % CO₂ | % CO₂ | Average | St. Dev | Co. Var |
| | uptake | uptake | uptake | % | % | % |
| Sample A | 2.90 | 2.90 | 3.02 | 2.94 | 0.07 | 2.3 |
| Sample B | 2.71 | 2.63 | 2.76 | 2.70 | 0.06 | 2.4 |
| Sample C | 2.60 | 2.60 | 2.80 | 2.67 | 0.12 | 4.3 |

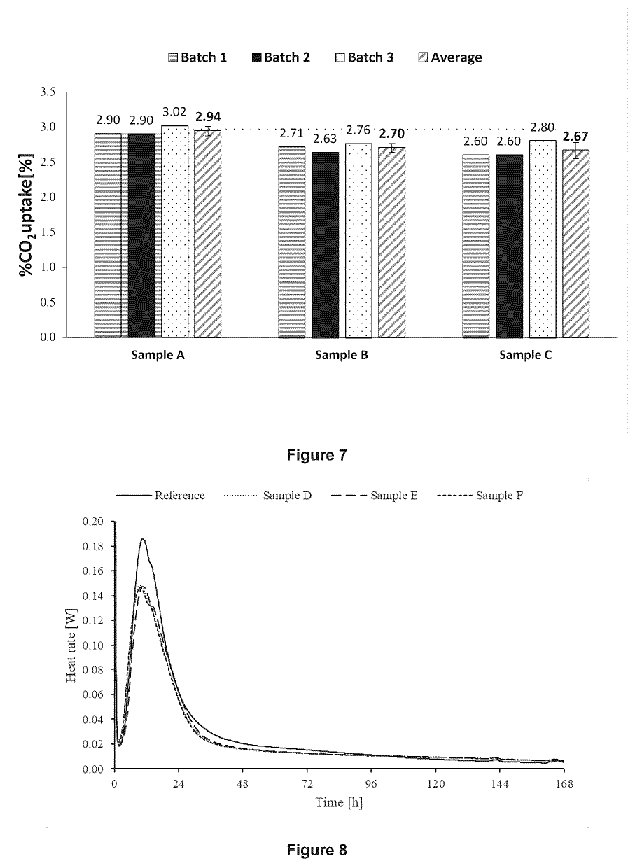

The results are shown in FIG. 7.

The results show that combined wet milling and carbonation of the invention led to an improvement in carbon dioxide uptake with respect to both comparative Example B and Example C. Specifically, the average result of Example A is 8.8% higher than value from Example B and 10.2% higher than value from Example C. This surprisingly shows the advantage of wet milling in the presence of carbon dioxide over carrying out these steps separately.

### Example 2

The hydration reactivity of the carbonated powders was assessed by calorimetry. The test consisted of creating fresh paste samples (powder and water) and placing them for 7 days at 23° C. in sealed vials inside an insulated container. During the entire testing time, heat release was recorded. Four different samples were tested, with 2 repetitions for each sample.

Table 3 shows the processes applied to the four samples, with Sample D being in accordance with the present invention.

TABLE 3

| | |
|---|---|
| Reference sample | 2 reference samples characterised by 40 g |
| | of cement of type CEM I 52.5 N and 20 g |
| | of water, with a liquid-to-solid ratio of 0.5 |
| Sample D | 2 samples characterised by 32 g of cement |
| | of type CEM I 52.5 N, 8 g of ground steel |
| | convertor slag, with a liquid-to-solid ratio of |
| | 0.5, treated by means of the “Example A” |
| | process set out above |
| Sample E | 2 samples characterised by 32 g of cement |
| | of type CEM I 52.5 N, 8 g of ground steel |
| | convertor slag, with a liquid-to-solid ratio of |
| | 0.5, treated by means of the “Example B” |
| | process” set out above and 20 g of water |
| Sample F | 2 samples characterised by 32 g of cement |
| | of type CEM I 52.5 N, 8 g of ground steel |
| | convertor slag, with a liquid-to-solid ratio of |
| | 0.5, treated by means of the “Example C” |
| | process set out above and 20 g of water |

The results are expressed in terms of heat rate over time, in watts, and cumulative heat over time, in joules. For each sample, the average curve of the two repetitions is shown. The results are also expressed by dividing the heat for the amount of cement present in the sample concerned (specific heat rate and specific cumulative heat).

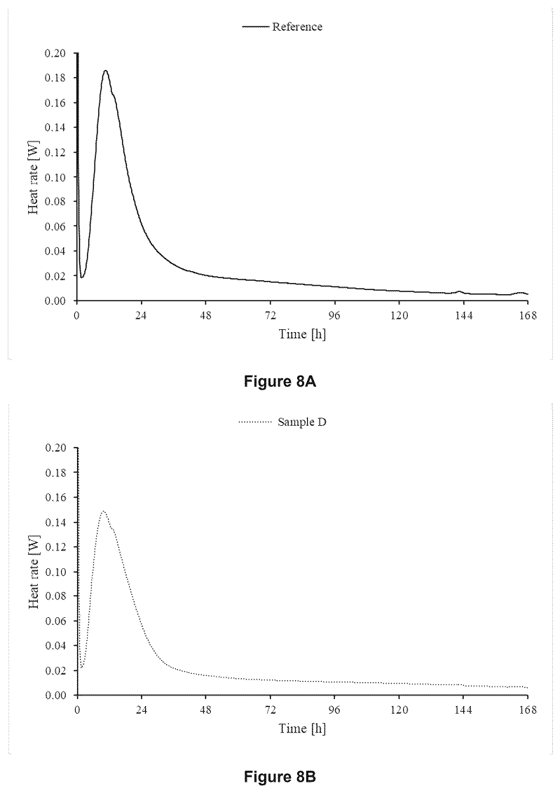

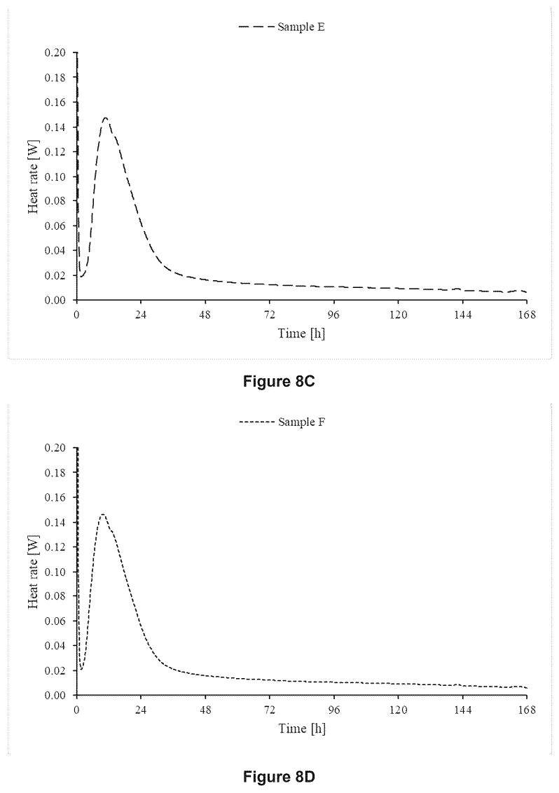

FIG. 8 and FIGS. 8A-8D show the heat rate evolution over time for each sample. The heat of hydration curve shown in FIG. 8 illustrates the five stages of the hydration reaction: the initial reaction, the induction period, the acceleratory period, the deceleratory period and the period of slow continued reaction. The heat released during the initial stage of the reaction (the first hour) is not considered to be significant, as the calorimeter system required a certain time to reach equilibrium status after a sample was loaded.

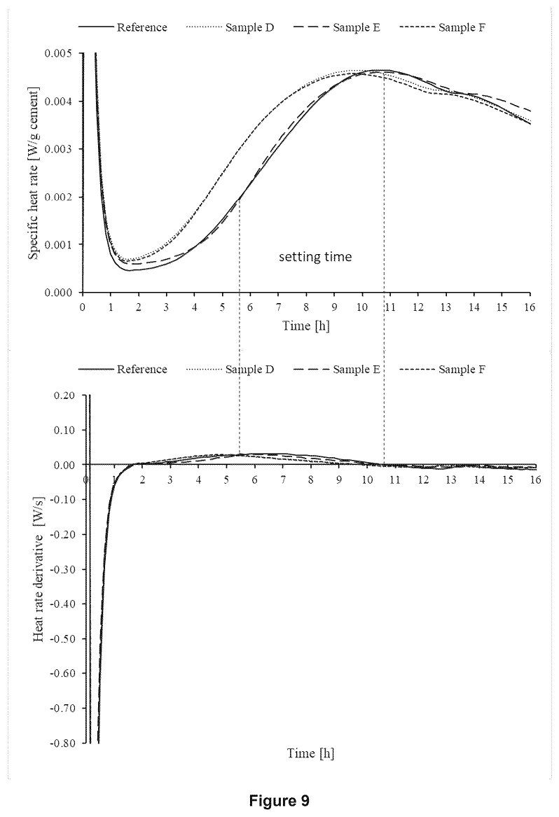

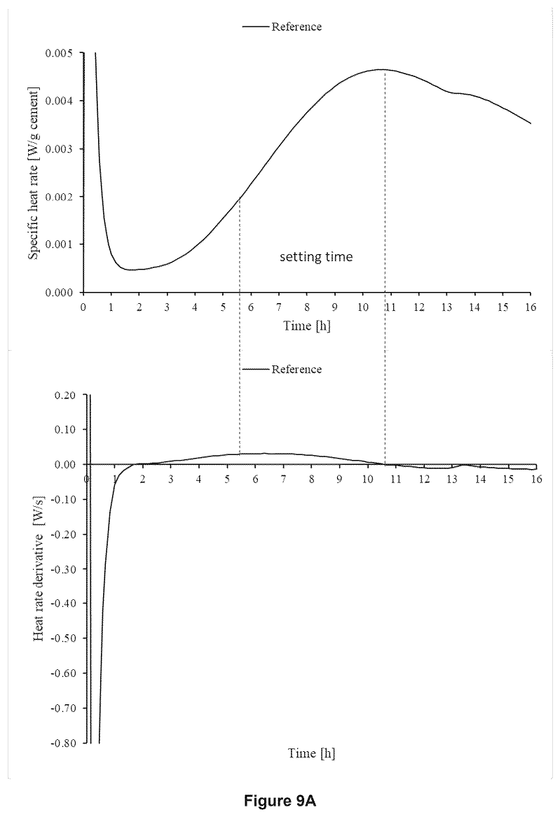

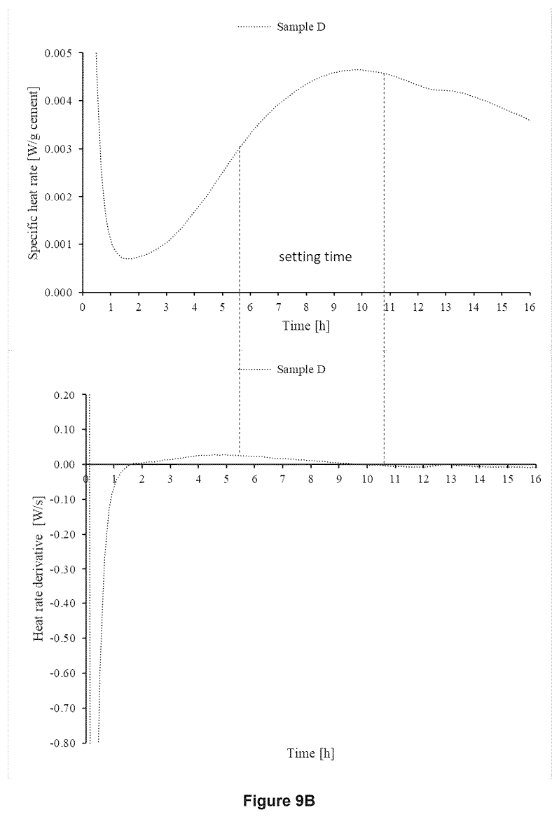

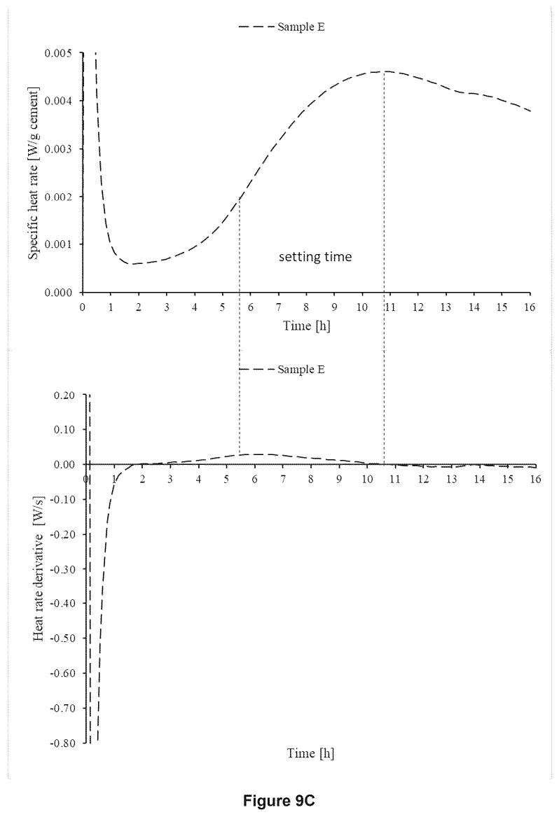

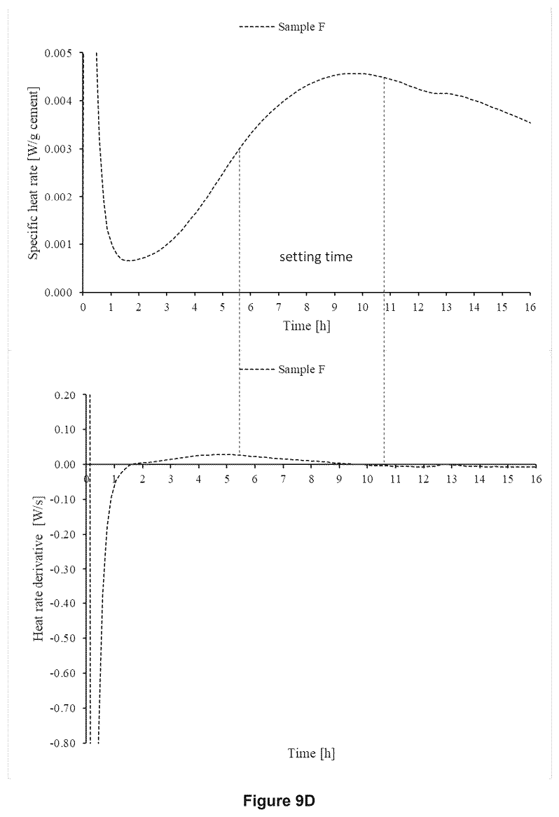

Setting occurs during the acceleratory period that is the increasing branch before the maximum point (shown to be occurring at around 6 h). Specifically, initial and final setting time are defined as the values corresponding to which the first derivative of the heat rate respectively assumes the maximum value and a value equal to zero (shown in FIG. 9 and FIGS. 9A-9D).

FIGS. 9B and 9D shows that Sample D and Sample F (which correspond, respectively, with the combined wet carbonation and wet grinding method of the present invention and the method with sequential wet carbonation and wet grinding steps) are characterised by a lower setting time with respect to the reference sample. Conversely this accelerating behaviour is not observed for Sample E in FIG. 9C (corresponding with sequential wet grinding and wet carbonation steps).

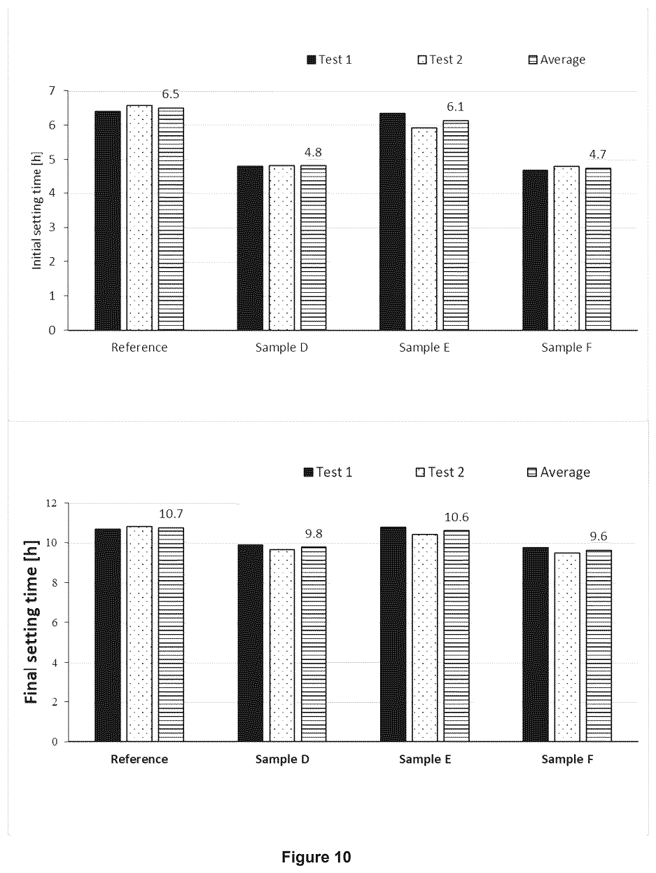

Initial and final time of setting is reported for each sample in FIG. 10, which shows a reduction in setting time for Samples D and F compared to the Reference sample and Sample E. The accelerating effect may be due to the presence of calcium carbonate formed during the carbonation process.

FIGS. 9, 9A-9D and 10 show a clear reduction in setting time for Sample D, which corresponds with the present invention. As outlined in the description, reducing the setting time increases the efficiency of the process.

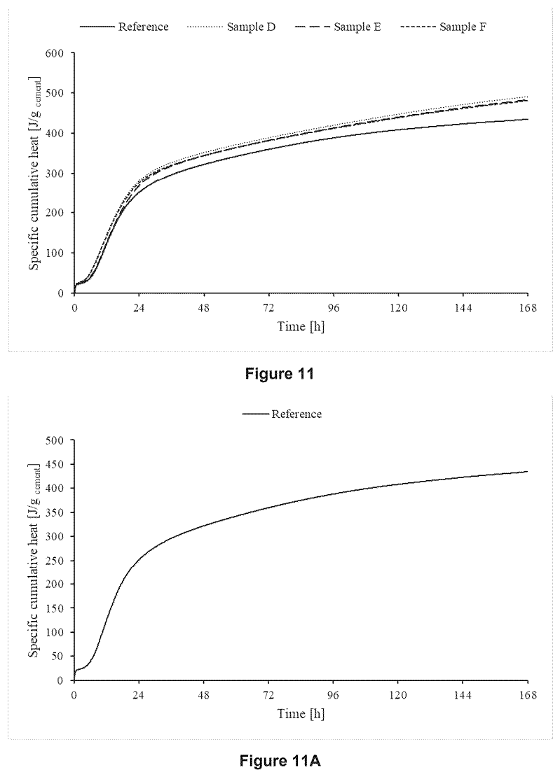

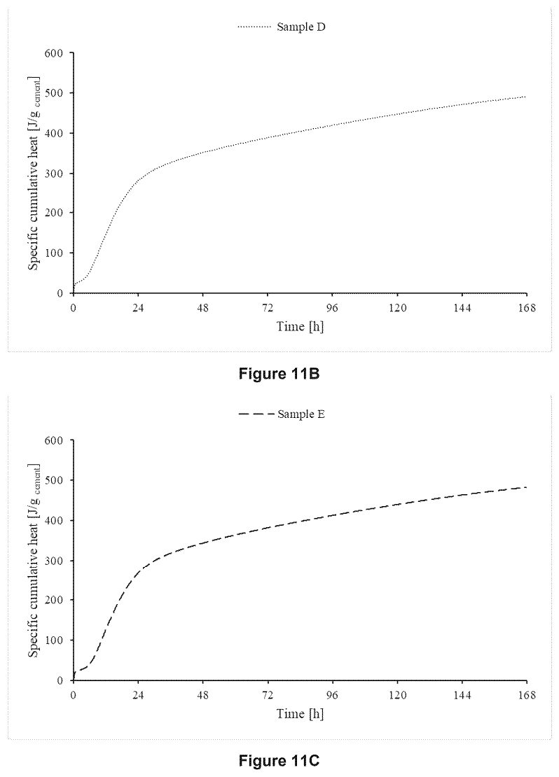

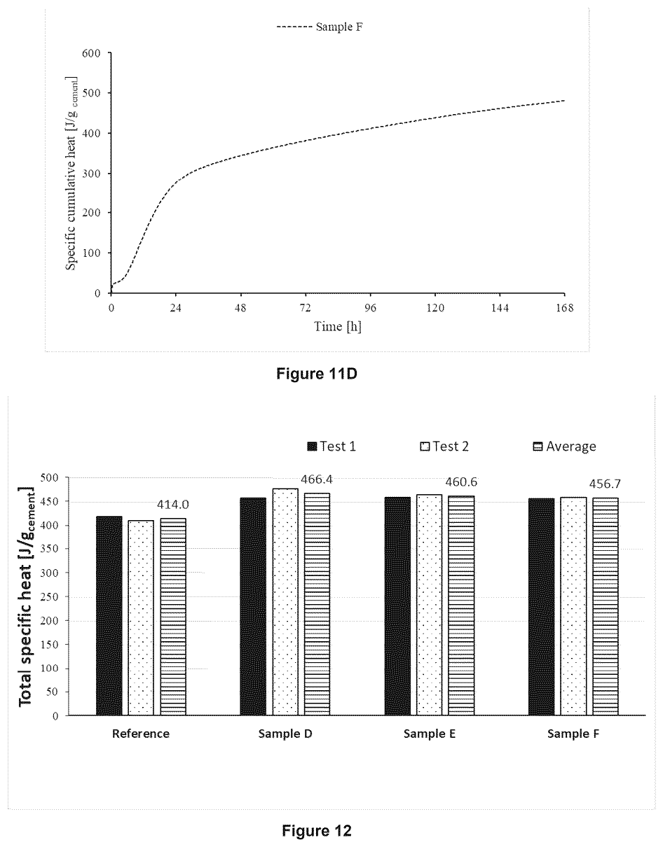

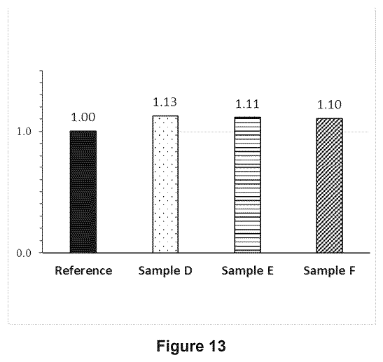

FIG. 11 and FIGS. 11A-11D show cumulative heat for each sample, normalised relative to the cement component. Cumulative heat must be normalised to account for the known “filler effect”, which occurs when other materials are added to the cement blend. FIG. 11, FIGS. 11A-11D and FIG. 12 show the contribution of added SCM to the hydration reaction, with the normalised cumulative heat for Samples D, E and F being higher than for the Reference sample. In FIG. 13, the contribution of SCM to hydration is expressed as the increase of the normalised cumulative heat relative to the reference sample. FIG. 13 indicates that Sample D (produced according to the claimed method) had a higher normalised cumulative heat relative to Samples E and F, supporting the statement that the combined wet carbonation and wet grinding method of the present invention improves the compressive strength development of the concrete, mortar or cement.

These results are statistically significant because, for example, the repeatability standard deviation of the hydration heat is 4 J×g⁻¹ for Sample D, which is within the accepted range of 10 J×g⁻¹.

The present invention may be described in accordance with the following clauses:
1. A method of producing a supplementary cementitious material (SCM) comprising:
   a) providing a particulate mineral material;
   b) mixing the mineral material with water to form a mixture;
   c) milling the mixture in the presence of carbon dioxide to form a slurry, wherein the concentration of carbon dioxide is greater than about 8 vol %; and;
   d) drying the slurry to form the SCM.
2. A method according to clause 1, further comprising:
   e) deagglomerating the SCM.
3) A method according to clause 2, wherein step (e) comprises deagglomerating and milling the SCM.
4) A method according to any preceding clause, wherein the mineral material comprises a calcium oxide, a magnesium oxide, a calcium silicate, a magnesium silicate, an iron oxide or a combination of two or more thereof, preferably a calcium oxide, a magnesium oxide or a combination of the two; and/or
   wherein the particulate mineral material comprises blast furnace slag, meta kaolin, calcinated clay, serpentine, Portland cement, cement by-pass dust, lime kiln dust, cement kiln dust, air pollution control residue, Portland clinker, cement, limestone powder, quicklime, rock fines, concrete fines, mine tailings, fly ash, bottom ash, biomass ash, metallurgy slag, red mud, paper ash, dusts, oil shale ash, metal silicate powder, metal hydroxide powder, calcium sulphate, pozzolanic material or bleaching earth material, or any combination of two or more thereof, preferably, the particulate mineral material comprises blast furnace slag, metallurgy slag, Portland cement, Portland clinker, cement, air pollution control residue or any combination of two or more thereof, preferably, the particulate mineral material comprises steel slag, stainless steel slag, copper slag, lead slag, Portland cement, Portland clinker, cement, cement by-pass dust, lime kiln dust, cement kiln dust, fly ash or bottom ash or any combination of two or more thereof, preferably, the particulate mineral material comprises blast furnace slag or metallurgy slag, preferably the particulate mineral material comprises metallurgy slag, preferably steel slag or stainless steel slag; and/or wherein the particulate mineral material comprises blast furnace slag, cement by-pass dust, lime kiln dust, cement kiln dust, concrete fines, mine tailings, fly ash, bottom ash, metallurgy slag, red mud, metal silicate powder, metal hydroxide powder, or any combination of two or more thereof, preferably wherein the particulate mineral material comprises blast furnace slag, cement by-pass dust, lime kiln dust, cement kiln dust, concrete fines, mine tailings, fly ash, bottom ash, metallurgy slag, red mud, or any combination of two or more thereof.
5) A method according to any preceding clause, wherein the liquid to solid ratio in step (b) is in the range of about 5 to about 1 to about 1 to about 1, preferably wherein the liquid to solid ratio is about 5 to about 1, most preferably wherein the liquid to solid ratio is about 2 to about 1.
6) A method according to any preceding clause, wherein the mixture in step (b) further comprises from about 0.1 wt % to about 5 wt % sodium hydroxide, preferably from about 0.5 wt % to about 3 wt % sodium hydroxide, preferably from about 1 wt % to about 2 wt % sodium hydroxide
7) A method according to any preceding clause, wherein the mixture in step (b) further comprises from about 0.1 wt % to 5 wt % of titanium dioxide, preferably from about 0.5 wt % to about 3 wt % titanium dioxide, preferably about 1 wt % titanium dioxide.
8) A method according to any preceding clause, wherein step (c) is carried out at a temperature of at least about 40° C., preferably in the range of about 40° C. to about 99° C., preferably in the range of about 50°° C. to about 70° C.
9) A method according to any preceding clause, wherein the concentration of carbon dioxide in step (c) is in the range of about 8 vol % to about 100 vol %, preferably in the range of about 10 vol % to about 50 vol %, preferably in the range of about 13 vol % to about 20 vol %.
10) A method according to any preceding clause, wherein the carbon dioxide in step (c) comprises flue gas.
11) A method according to any preceding clause, wherein the D90 particle size of the mineral material is less than about 50 mm, preferably from about 100 μm to about 5 mm, preferably from about 200 μm to about 5 mm, preferably from about 300 μm to about 1 mm.
12) A method according to any preceding clause, wherein the D90 particle size of the SCM is from about 60 μm to about 500 μm, preferably from about 50 μm to about 300 μm, preferably from about 70 μm to about 110 μm, preferably from about 80 μm to about 90 μm
13) A method according to any preceding clause, wherein step (c) is carried out at a pressure in the range of about 1 bar to about 3 bar, preferably about 1 bar.
14) A method according to any preceding clause, wherein the milling time in step (c) is in the range of about 2 hours and about 5 hours, preferably about 3 hours to about 4 hours.
15) A method according to any preceding clause, wherein step (d) is carried out at a temperature from about 40° C. to about 120° C., preferably about 60° C. to about 110° C., preferably about 95° C. to about 105° C.
16) A method according to any preceding clause, wherein the concentration of carbon dioxide in step (d) is greater than about 8 vol %; preferably in the range of about 8 vol % to about 100 vol %, preferably in the range of about 13 vol % to about 20 vol %.
17) A method according to any preceding clause, wherein the drying time in step (d) is from about 1 hour to about 24 hours, preferably about 1 hour to about 5 hours, preferably about 2 hours to about 4 hours.
18) A method according to any preceding clause, wherein the slurry is dried using flue gas, preferably flue gas from a cement plant.
19) A method according to any preceding clause, wherein flue gas is used to provide the carbon dioxide in step (c) and to dry the slurry in step (d), preferably wherein the flue gas is recycled in steps (c) and (d).
20) A method according to clause 19, wherein the temperature of the flue gas is from about 120° C. to about 180° C.
21) A SCM produced by the method of any preceding clause.
22) Use of an SCM produced by the method of any of clauses 1 to 20 or an SCM according to clause 21, as a construction material, preferably in a method of producing concrete, mortar or cement.
23) A method of producing concrete comprising:
   i. providing a SCM produced according to any of clauses 1 to 20 or an SCM according to clause 21;
   ii. providing sand and an aggregate;
   iii. mixing the SCM, the sand, and the aggregate with water to form a mixture; and
   iv. curing the mixture to form concrete.
24) A method of producing mortar comprising:
   A. providing a supplementary cementitious material produced according to any of clauses 1 to 20 or an SCM according to clause 21;
   B. providing sand;
   C. providing water; and
   D. mixing the SCM, the sand, and the water to form mortar.
26) A method of producing cement comprising:
   I. providing a supplementary cementitious material produced according to any of clauses 1 to 20 or an SCM according to clause 21;
   II. providing a clinker;
   III. mixing the SCM and clinker to form cement.

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein and vice versa.

Within this specification, the term “about” means plus or minus 20%, more preferably plus or minus 20%, most preferably plus or minus 2%.

Within this specification, the term “substantially” means a deviation of plus or minus 20%, more preferably plus or minus 10%, even more preferably plus or minus 5%, most preferably plus or minus 2%.

Within this specification, reference to “substantially” includes reference to “completely” and/or “exactly”. That is, where the word substantially is included, it will be appreciated that this also includes reference to the particular sentence without the word substantially.

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications are covered by the appended claims

1. A method of producing a supplementary cementitious material (SCM) comprising:
a) providing a particulate mineral material;
b) mixing the mineral material with water to form a mixture;
c) milling the mixture in the presence of carbon dioxide to form a slurry, wherein the concentration of carbon dioxide is greater than about 8 vol %; and;
d) drying the slurry to form the SCM.

2. A method according to claim 1, further comprising:
e) deagglomerating the SCM.

3. (canceled)

4. (canceled)

5. A method according to claim 1, wherein the particulate mineral material comprises metallurgy slag.

6. A method according to claim 1, wherein the mineral material comprises a calcium oxide, a magnesium oxide, a calcium silicate, a magnesium silicate, an iron oxide or a combination of two or more thereof.

7. A method according to claim 1, wherein the liquid to solid ratio in step (b) is in the range of 5:1 to 1:1.

8. A method according to claim 1, wherein the mixture in step (b) further comprises from 0.1 wt % to 5 wt % sodium hydroxide.

9. A method according to claim 1, wherein step (c) is carried out at a temperature of at least 40° C.

10. A method according to claim 1, wherein the concentration of carbon dioxide in step (c) is in the range of 8 vol % to 100 vol %.

11. A method according to claim 1, wherein the D90 particle size of the mineral material is less than 50 mm.

12. A method according to claim 1, wherein step (d) is carried out at a temperature from 40° C. to 120° C.

13. (canceled)

14. A method according claim 1, wherein the particulate mineral material comprises blast furnace slag or metallurgy slag, and wherein the method further comprises:
deagglomerating the SCM.

15. (canceled)

16. (canceled)

17. (canceled)

18. Use of an SCM produced by the method of claim 1, as a construction material in a method of producing concrete, mortar or cement.

19. A method of producing concrete comprising:
i. providing a SCM produced according to claim 1;
ii. providing sand and an aggregate;
iii. mixing the SCM, the sand, and the aggregate with water to form a mixture; and
iv. curing the mixture to form concrete.

20. (canceled)

21. (canceled)

22. A method according to claim 1, further comprising:
e) deagglomerating and milling the SCM.

23. A method according to claim 1, wherein the mixture in step (b) further comprises from 0.1 wt % to 5 wt % of titanium dioxide.

24. A method according to claim 1, wherein the milling time in step (c) is in the range of 2 hours to 5 hours.

25. A method according to claim 1, wherein the carbon dioxide in step (c) comprises flue gas.

26. A method according to claim 25, wherein flue gas is used to provide the carbon dioxide in step (c) and to dry the slurry in step (d).

27. A method according to claim 1, wherein the D90 particle size of the SCM is from 60 μm to 500 μm.

28. A method according to claim 25, wherein the flue gas is recycled in steps (c) and (d).
